(19) United States
(12) Patent Application Publication
(10) Pub. No.: US 2014/0166833 A1
(43) Pub. Date: Jun. 19, 2014

(54) RESIN BRACKET AND BRACKETED VIBRATION DAMPING DEVICE EQUIPPED THEREWITH

(71) Applicant: TOKAI RUBBER INDUSTRIES, LTD., Aichi (JP)

(72) Inventor: Kei OKUMURA, Gifu (JP)

(73) Assignee: TOKAI RUBBER INDUSTRIES, LTD., Aichi (JP)

(21) Appl. No.: 14/097,648

(22) Filed: Dec. 5, 2013

(30) Foreign Application Priority Data
Dec. 18, 2012 (JP) 2012-275424

(51) Int. Cl. B60K 5/12

(52) U.S. Cl. CPC B60K 5/1266
USPC 248/222.14

(57) ABSTRACT

A resin bracket including a mounting unit and a plurality of attachment units integrally formed using synthetic resin, and a plurality of insert members arranged on the respective attachment units such that each of the attachment units is configured to be attached to a member constituting a vibration transmission system by a fastening member configured to be inserted in an inner hole formed on an inside of the corresponding insert member. The insert members are formed in mutually a same shape. An inner circumference resin layer integrally formed with the attachment unit is adhered to an inner circumference surface on at least one of the insert members. The inner hole of the insert member formed on the inside of the inner circumference resin layer has a different shape from the inner hole of at least one other insert member.

### INCORPORATED BY REFERENCE

The disclosure of Japanese Patent Application No. 2012-275424 filed on Dec. 18, 2012 including the specification, drawings and abstract is incorporated herein by reference in its entirety.

### BACKGROUND OF THE INVENTION

1. Field of the Invention

The present invention relates to a resin bracket for a vibration damping device used for an automobile engine mount or the like, and to a bracketed vibration damping device equipped therewith.

2. Description of the Related Art

From the past, vibration damping devices interposed between members constituting vibration transmission systems were typically attached via a bracket to the members constituting the vibration transmission system. This bracket is equipped with a mounting unit to the vibration damping device, and a plurality of attachment units fixed to the members constituting the vibration transmission system. An example of that is shown in Japanese Unexamined Patent Publication No. JP-A-2012-013153.

However, the bracket of the vibration damping device requires high rigidity, so is formed with a metal such as an aluminum alloy or the like, but recently, to realize a higher level of weight reduction, resin brackets formed with a synthetic resin such as that in JP-A-2012-013153 have been proposed. With the resin bracket, the mounting unit and the plurality of attachment units are integrally formed using synthetic resin, and also, an insert member made of metal equipped with an inner hole is attached to each attachment unit.

However, when using a single shape insert member for the plurality of attachment units of the resin bracket, it becomes necessary to unify the diameters and the like of the bolts inserted in the inner hole of the insert member, and there is the risk that the level of freedom of design of the fastening structure for the structural members of the vibration transmission system will be restricted. Also, by using insert members of respectively different shapes for the plurality of attachment units, it is thought that the problems noted above can be avoided, but in that case, since a plurality of types of insert members of different shapes is required, there is the problem of errors in arranging each insert member during manufacturing, an increase in manufacturing cost for the insert members, and the like.

### SUMMARY OF THE INVENTION

It is therefore one object of the present invention to provide a resin bracket of a novel structure that is able to realize easy manufacturing and lower cost while ensuring freedom of design of the fastening structure for the structural elements of the vibration transmission system.

Another object of the present invention is to provide a vibration damping device equipped with the resin bracket as described above.

Specifically, a first mode of the present invention provides a resin bracket including: a mounting unit configured to be attached to a vibration damping device; a plurality of attachment units configured to be attached to a member constituting a vibration transmission system, the mounting unit and the attachment units being integrally formed using synthetic resin; and a plurality of insert members arranged on the respective attachment units such that each of the attachment units is configured to be attached to the member constituting the vibration transmission system by a fastening member configured to be inserted in an inner hole formed on an inside of the corresponding insert member, wherein the insert members are formed in mutually a same shape, an inner circumference resin layer integrally formed with the attachment unit is adhered to an inner circumference surface on at least one of the insert members, and the inner hole of the insert member formed on the inside of the inner circumference resin layer has a different shape from the inner hole of at least one other insert member.

With the resin bracket constituted according this kind of first mode, it is possible to obtain a plurality of different types of inner holes of different shapes with the single shape insert member. Because of that, it is not necessary to have a plurality of types of insert member of different shapes, and it is possible to deal with fastening structures that are different for each attachment unit (difference in the bolt diameter, bolt cross section shape or the like), or to allow relative positional deviation of the attachment units in relation to the structural elements of the vibration transmission system due to member dimension error or the like.

Furthermore, since the insert member is made to be common to all the attachment units, it is possible for the insert member to be excellent for mass production, and to be inexpensive.

Also, the inner circumference resin layer adhered to the inner circumference surface of the insert member is integrally formed with the attachment unit adhered to the outer circumference surface of the insert member, so it is possible to easily obtain inner holes of different shapes without increasing the number of forming steps.

A second mode of the present invention provides the resin bracket according to the first mode, wherein at an opening end surface of the inner hole of the at least one insert member, a connection groove connecting the inside and an outside of the insert member is formed, and the attachment unit and the inner circumference resin layer are integrally formed through the connection groove.

With the second mode, it is possible to keep the joint part of the attachment unit and the inner circumference resin layer within the inside of the connection groove, so after-processing such as machining or the like is not required. In fact, by the joint part of the attachment unit and the inner circumference resin layer being formed inside the connection groove, the insert member is positioned with respect to the attachment unit, and falling out of the insert member from the attachment unit is prevented.

A third mode of the present invention provides the resin bracket according to the second mode, wherein the connection groove is formed on each opening end surface of the inner hole of the at least one insert member, and the attachment unit and the inner circumference resin layer are integrally formed through each connection groove.

With the third mode, it is possible to send resin material from both axial direction end parts to the inner circumference side of the insert member, and it is possible to efficiently form the inner circumference resin layer on the inner circumference side of the insert member.

Also, by the joint part of the attachment unit and the inner circumference resin layer being locked to the connection groove of each axial direction side, the insert member is positioned at both axial direction sides in relation to the attachment unit, and falling out of the insert member in the axial direction in relation to the attachment unit is more effectively prevented.

A fourth mode of the present invention provides the resin bracket according to any one of the first through third modes, wherein the insert member comprises a tube shaped forged metal member, a positioning projection is provided on the insert member projecting facing an outer circumference, and a positioning member that positions the insert member in relation to the attachment unit is constituted by the positioning projection.

With the fourth mode, by having the insert member be a tube shaped forged metal member, it is possible to easily obtain an insert member equipped with a positioning projection, and by adhering and locking the positioning projection to the attachment unit, falling out of the insert member from the attachment unit is effectively prevented.

A fifth mode of the present invention provides the resin bracket according to any one of the first through third modes, wherein the insert member comprises a pipe metal member, and a positioning member is provided for positioning the insert member in relation to the attachment unit.

With the fifth mode, by having the insert member be a tube shaped pipe metal member, it is possible to obtain the insert member easily and inexpensively. Furthermore, by providing the positioning member, even if the insert member is a pipe metal member, it is possible to effectively prevent falling out from the attachment unit. As the positioning member, as shown with the second and third modes, a constitution is used that arranges the joint part of the attachment unit and the inner circumference resin layer inside the connection groove and locks it, but for example, it is also possible to use a constitution as shown with the sixth mode below.

A sixth mode of the present invention provides the resin bracket according to the fifth mode, wherein a connection hole that connects the inside and an outside is formed piercing through the insert member, and the attachment unit and the inner circumference resin layer are integrally formed through the connection hole.

With the sixth mode, since positioning of the insert member in relation to the attachment unit is realized at both axial direction sides with one connection hole, it is possible to efficiently do positioning with a low number of working processes.

A seventh mode of the present invention provides the resin bracket according to any one of the first through sixth modes, wherein the inner circumference resin layer is partially adhered to the inner circumference surface of the insert member.

With the seventh mode, by the inner circumference resin layer being partially adhered in the axial direction to the insert member, it is possible to effectively obtain the target inner hole shape while saving the forming materials of the inner circumference resin layer. Meanwhile, if the inner circumference resin layer is partially adhered in the circumference direction to the insert member, it is possible to obtain a different shaped hole having an oval cross section or the like as the inner hole using a small amount of material.

An eighth mode of the present invention provides the resin bracket according to any one of the first through seventh modes, wherein the inner circumference resin layer is adhered along an entire circumference in relation to the inner circumference surface of the insert member.

With the eighth mode, it is possible to set the shape of the inner hole with an excellent degree of freedom. Specifically, by changing the thickness of the inner circumference resin layer on the circumference, it is possible to obtain an inner hole of different shapes such as an oval, ellipse or the like, and also, by making the thickness of the inner circumference resin layer different between a plurality of inner holes, it is possible to obtain a plurality of inner holes with different inner dimensions with similar shapes.

A ninth mode of the present invention provides a bracketed vibration damping device including: an attachment member configured to be attached to a first member constituting a vibration transmission system; a main rubber elastic body adhered to the attachment member; and a resin bracket according to any one of the first through eighth modes, wherein the attachment member and the mounting unit of the resin bracket are elastically connected by the main rubber elastic body, and the attachment units of the resin bracket are configured to be attached to a second member constituting the vibration transmission system.

With this kind of bracketed vibration damping device according to the ninth mode, mounting between the members constituting the vibration transmission system can be effectively realized using the resin bracket of a simple and inexpensive structure using common insert members.

With the present invention, by having insert members of the same shape arranged on a plurality of attachment units of the resin bracket, and having the inner circumference resin layer adhered on the inner circumference surface of at least one insert member, the inner hole of that insert member has a different shape from the inner hole of at least one other insert member. By doing this, it is possible to obtain a plurality of different types of inner holes of different cross sections or sizes while using common insert members, and it is possible to realize tolerance of dimension errors or handling of different attachment structures or the like without requiring a plurality of types of insert members. In fact, by forming the inner circumference resin integrally with the attachment unit, an increase in the number of parts due to changing the inner hole shape is avoided.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is a perspective view showing a bracketed vibration damping device in the form of an engine mount as a first embodiment of the present invention;

FIG. 2 is a perspective view of the engine mount shown in FIG. 1 shown from another angle;

FIG. 3 is an enlarged plan view of a principle part of a resin bracket constituting the engine mount shown in FIG. 1;

FIG. 4 is a cross section view taken along line 4-4 of FIG. 3;

FIG. 5 is an enlarged plan view of a principle part of the resin bracket constituting the engine mount shown in FIG. 1;

FIG. 6 is a cross section view taken along line 6-6 of FIG. 5;

FIG. 7 is an enlarged plan view of another principle part of the resin bracket constituting the engine mount shown in FIG. 1;

FIG. 8 is a cross section view taken along line 8-8 of FIG. 7;

FIG. 9 is an enlarged plan view of a principle part of a resin bracket constituting an engine mount as a second embodiment of the present invention;

FIG. 10 is a cross section view taken along line 10-10 of FIG. 9;

FIG. 11 is an enlarged plan view of another principle part of the resin bracket shown in FIG. 9;

FIG. 12 is a cross section view taken along line 12-12 of FIG. 11;

FIG. 13 is an enlarged plan view of yet another principle part of the resin bracket shown in FIG. 9;

FIG. 14 is a cross section view taken along line 14-14 of FIG. 11;

FIG. 15 is an enlarged plan view of a principle part of a resin bracket constituting an engine mount as a third embodiment of the present invention;

FIG. 16 is a cross section view taken along line 16-16 of FIG. 15;

FIG. 17 is an enlarged plan view of another principle part of the resin bracket shown in FIG. 15;

FIG. 18 is a cross section view taken along line 18-18 of FIG. 17;

FIG. 19 is an enlarged plan view of yet another principle part of the resin bracket shown in FIG. 15;

FIG. 20 is a cross section view taken along line 20-20 of FIG. 19; and

FIG. 21 is an enlarged vertical cross section view of a principle part of a resin bracket constituting an engine mount as another embodiment of the present invention.

### DETAILED DESCRIPTION OF PREFERRED EMBODIMENTS

Following, we will describe embodiments of the present invention while referring to the drawings.

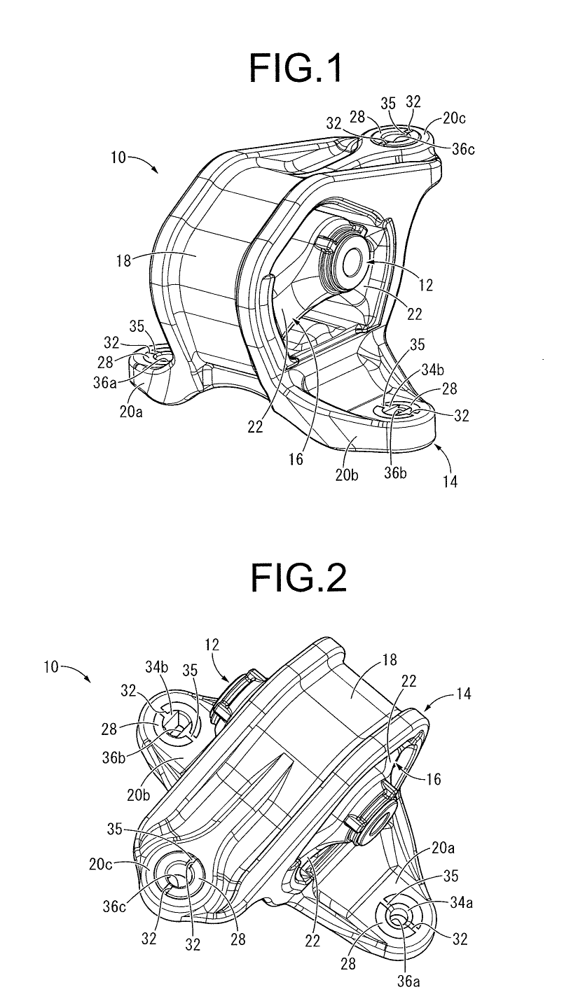

FIG. 1 and FIG. 2 show an engine mount 10 for an automobile as a first embodiment of the bracketed vibration damping device constituted according to the present invention. The engine mount 10 has a structure whereby an inner tube member 12 as an attachment member and a resin bracket 14 are elastically connected by a main rubber elastic body 16.

In more detail, the inner tube member 12 is a member exhibiting a thick, small-diameter, roughly round tube shape, and is a member with high rigidity formed using iron, an aluminum alloy or the like. The inner tube member 12 can also be a round tube shape extending with a roughly fixed cross section shape, but, for example, it is also possible to constitute a stopper means that restricts the relative displacement volume in the radial direction in relation to the resin bracket 14 described later by providing a bulge portion that broadens in diameter at the axial direction intermediate part, or by fixing a separate unit stopper member or the like.

With the resin bracket 14, attachment units 20a to 20c are integrally formed with a tube shaped mounting unit 18 using synthetic resin, and preferably, by forming with a fiber reinforced plastic for which glass fiber, carbon fiber or the like is mixed in as a reinforcing material, the load bearing capacity is improved. The synthetic resin material that forms the resin bracket 14 is not particularly restricted, but for example, it is possible to use a thermoplastic resin such as polyamide, polyethylene, polypropylene, polystyrene, polyvinyl chloride, polymethyl methacrylate, polyester, polycarbonate, polyacetal or the like, or thermosetting resins such as unsaturated polyester resin, phenol resin, epoxy resin, silicone resin or the like.

Then, the inner tube member 12 is arranged inserted so as to have the center axis direction be mutually roughly parallel in relation to the mounting unit 18 of the resin bracket 14, and the inner tube member 12 and the mounting unit 18 are elastically connected by the main rubber elastic body 16. The main rubber elastic body 16 is integrally equipped with a pair of connecting arm units 22, 22 extending in the radial direction between the inner tube member 12 and the mounting unit 18, and those connecting arm units 22, 22 elastically connect the inner tube member 12 and the mounting unit 18 to each other by vulcanization bonding of these connecting arm units 22, 22 to the outer circumference surface of the inner tube member 12 and the inner circumference surface of the mounting unit 18. With this embodiment, the mounting unit 18 of the resin bracket 14 is attached to the vibration damping device by vulcanization bonding to the main rubber elastic body 16.

With the engine mount 10 with this kind of structure, the inner tube member 12 is attached to a power unit (not illustrated) which is a first member constituting the vibration transmission system, and also the resin bracket 14 is attached to a vehicle body 24 which is a second member constituting the vibration transmission system. With the resin bracket 14, the attachment units 20a to 20c are joined and fixed by bolts 26 as fastening members to the vehicle body 24, and insert members 28 through which bolts 26 are inserted are arranged at the respective attachment units 20a to 20c.

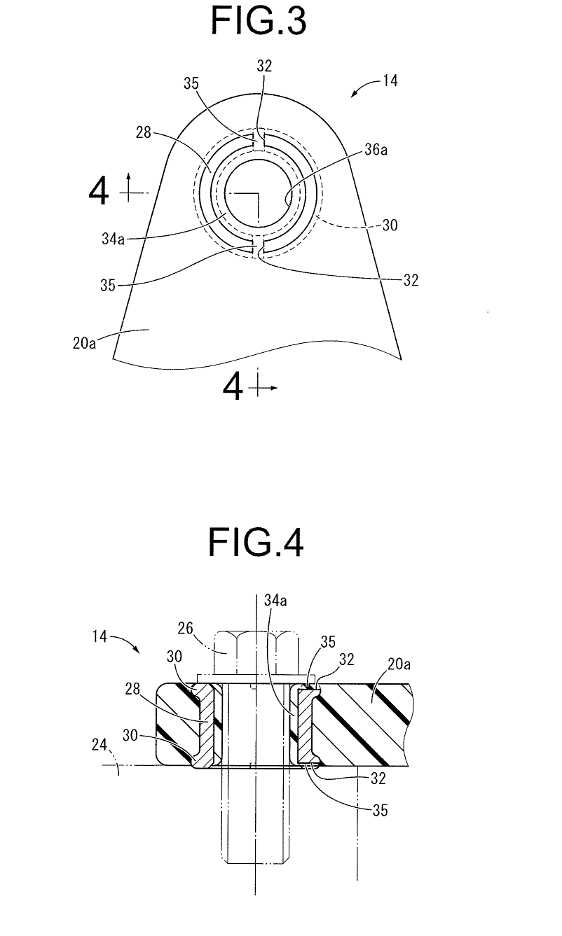

The insert member 28 is a tube shaped forged metal member formed by forging with iron, an aluminum alloy or the like as the material, and as shown in FIG. 3 to FIG. 8, has a roughly round tube shape. Furthermore, at both end parts of the axial direction (vertical in FIG. 4) of the insert member 28, a flange portion 30 is integrally formed as the positioning projection projecting facing the outer circumference. Yet further, at each axial direction end part of the insert member 28, a connection groove 32 is formed extending in one direction of the radial direction while being open at the axial direction end surface, and the inside (center hole) and the outside (outer circumference area) of the insert member 28 are connected to each other by the connection groove 32.

As shown in FIG. 1 and FIG. 2, these insert members 28 are arranged on the respective attachment units 20a to 20c of the resin bracket 14. Specifically, by three insert members 28 undergoing insert formation by being set in the forming mold in advance when forming the resin bracket 14, each insert member 28 is adhered formed with mutually the same shape on the corresponding attachment unit 20a to 20c. Also, the insert members 28 have both axial direction end surfaces exposed to the outside from the attachment unit 20. In particular with this embodiment, with the attachment units 20a and 20b, the overlapping surface of the insert member 28 on the vehicle body 24 projects further to the outside than the attachment units 20a and 20b, and reliably abuts the vehicle body 24. Meanwhile, with the attachment unit 20c, the overlapping surface on the bolt 26 projects further to the outside than the attachment unit 20c, and the seating surface of the bolt 26 is ensured. Furthermore, by the attachment unit 20 being inserted and adhered between the axial direction of the upper and lower pair of flange portions 30, 30 provided on the insert member 28, falling out of the insert member 28 is prevented, thereby constituting a positioning member of the present embodiment. Otherwise, if the flange portion 30 is provided at the axially intermediate part of the insert member 28, and the attachment unit 20 is adhered to both the upper and lower surfaces of the flange portion 30, it is possible to constitute the positioning member for realizing positioning at both axial direction sides using one flange portion 30.

Here, an inner circumference resin layer 34a is adhered on the inner circumference surface of the insert member 28 arranged on the attachment unit 20a (see FIG. 3 and FIG. 4). The inner circumference resin layer 34a is adhered to roughly the entire surface of the inner circumference surface of the insert member 28, and as shown in FIG. 3, has roughly a round tube shape continuously along the entire circumference. Also, as shown in FIG. 4, the inner circumference resin layer 34a is integrally formed with the attachment unit 20a through the connection groove 32 formed at each axial direction end part of the insert member 28, and on the inner surface of the connection groove 32, a locking portion 35 is adhered that connects the attachment unit 20a and the inner circumference resin layer 34a. In this way, by the roughly round tube shaped inner circumference resin layer 34a being adhered to the inner circumference surface of the insert member 28, an inner hole 36a that pierces in the axial direction with a small diameter circular cross section is formed on the inside of the insert member 28.

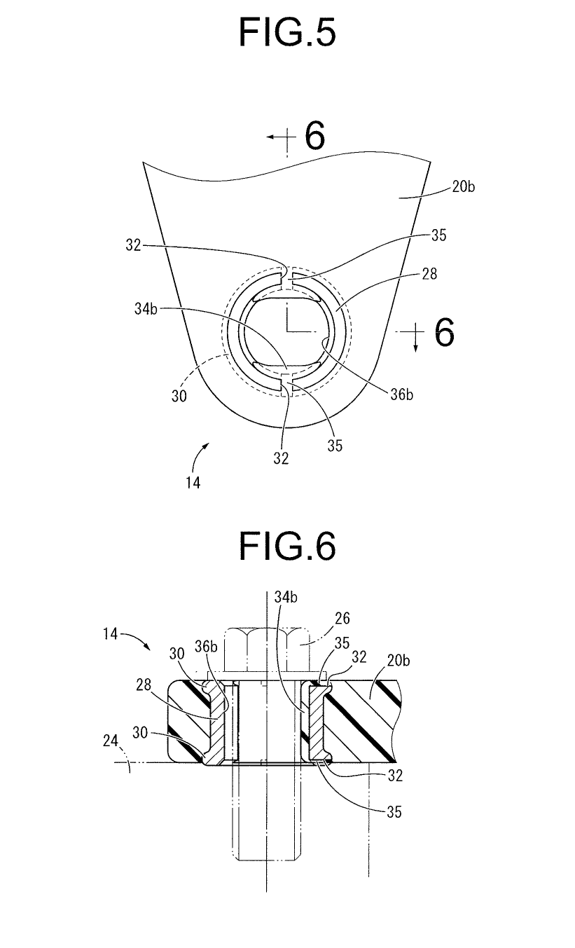

Also, an inner circumference resin layer 34b is adhered to the inner circumference surface of the insert member 28 arranged on the attachment unit 20b (see FIG. 5 and FIG. 6). The inner circumference resin layer 34b is adhered partially on the circumference and along roughly the entire length of the axial direction in relation to the inner circumference surface of the insert member 28, and is integrally formed with the attachment unit 20b via the locking portion 35 adhered to the connection groove 32. In more specific terms, as shown in FIG. 5, it is adhered broadening to both sides in the circumference direction from the connection groove 32 forming part on the circumference of the insert member 28, and the pair of inner circumference resin layers 34b, 34b are formed facing opposite in one direction of the radial direction. Furthermore, the opposite facing surfaces of the pair of inner circumference resin layers 34b, 34b have a small curvature of the circumference direction in relation to the inner circumference surface of the insert member 28, and with this embodiment, are roughly parallel broadening in the direction orthogonal to the opposite facing direction. In this way, by the roughly round tube shaped inner circumference resin layers 34b, 34b being adhered to the inner circumference surface of the insert member 28, on the inside of the insert member 28 is formed an inner hole 36b that pierces therethrough in the axial direction with the roughly oval shaped cross section which has the opposite facing direction of the pair of inner circumference resin layers 34b, 34b as the minor axis.

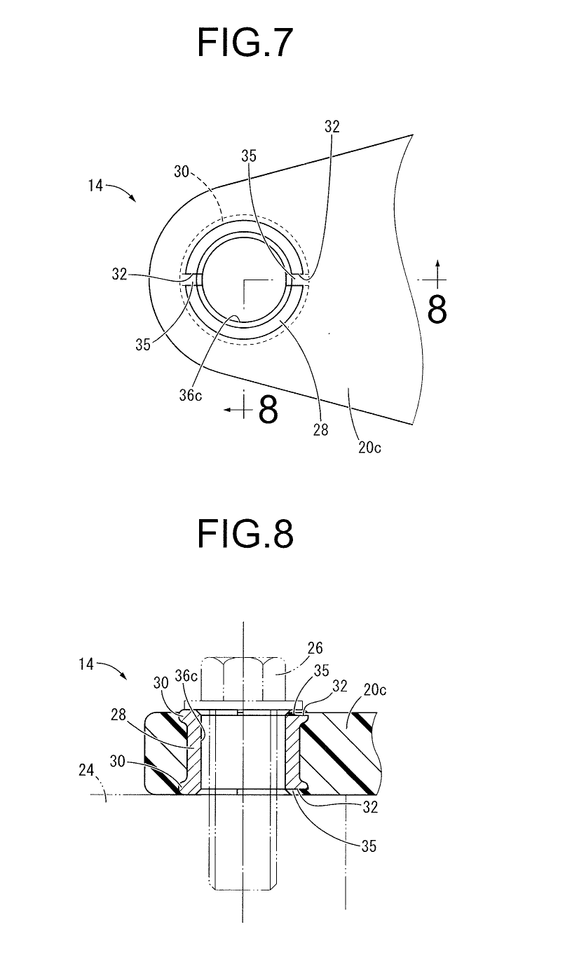

Also, as shown in FIG. 7 and FIG. 8, the insert member 28 arranged on the attachment unit 20c has the locking portion 35 integrally formed with the attachment unit 20c extending out and adhered inside the connection groove 32, and also, the inner circumference surface is exposed to the inside along its entirety. By doing this, the inner hole 36c that has a circular cross section with a larger diameter than the inner hole 36a is formed piercing in the axial direction on the inside of the insert member 28 arranged on the attachment unit 20c.

In this way, the three insert members 28 adhered to the attachment units 20a to 20c are members having mutually the same structure, and also, the inner holes 36a to 36c of the respective insert members 28 have mutually different shapes. It is sufficient that at least one inner hole 36 has a different shape in relation to at least one of the other inner holes 36, and with the resin bracket 14 of this embodiment having three inner holes 36a to 36c, it is also possible for two inner holes 36, 36 to have the same shape.

Then, by the difference in shape of the inner holes 36a to 36c, dimension error of the attachment part of the resin bracket 14 or vehicle body 24 side is allowed, and an attachment defect of the resin bracket 14 to the vehicle body 24 is avoided. In specific terms, for example, first, the bolt 26 is inserted through the inner hole 36a of the insert member 28 arranged on the attachment unit 20a, and the attachment unit 20a is attached to the vehicle body 24 by the bolt 26. The internal dimension of the inner hole 36a is roughly the same as the diameter of the bolt 26, and the attachment unit 20a is positioned with respect to the vehicle body 24 by screwing in of the bolt 26.

Next, the bolt 26 is inserted through the inner hole 36b of the insert member 28 arranged on the attachment unit 20b, and the attachment unit 20b is attached to the vehicle body 24 by the bolt 26. With the inner hole 36b, the internal dimension in the minor axis direction is roughly the same as the diameter of the bolt 26, and the internal dimension in the major axis direction is larger than the diameter of the bolt 26, and attachment position deviation is allowed in the major axis direction.

Finally, the bolt 26 is inserted through the inner hole 36c of the insert member 28 arranged on the attachment unit 20c, and the attachment unit 20c is attached to the vehicle body 24 by the bolt 26. Since the internal dimension of the inner hole 36c is larger than the diameter of the bolt 26, insertion of the bolt 26 is done with a gap left, and with the attachment unit 20c, attachment position deviation is allowed in all directions that are directions perpendicular to the axis. Based on the above, even when attachment position deviation occurs due to dimension error of the member or the like, it is possible to attach the attachment units 20a to 20c respectively to designated positions of the vehicle body 24.

Also, the three insert members 28 arranged on the attachment units 20a to 20c have the same roughly round tube shape to each other, and all the center holes have a circular cross section. This makes it possible to make those insert members 28 as uniformed parts, as well as to easily manufacture the insert members 28 using forging. Furthermore, the connection groove 32 for integrally joining the attachment unit 20 and the inner circumference resin layer 34 opens at each end surface in the axial direction of the insert member 28, and it is possible to form the connection grooves 32 simultaneously with forging of the insert member 28.

Also, with this embodiment, the inner circumference resin layers 34a, 34b are both adhered along the entire length in the axial direction to the inner circumference surface of the insert member 28, so a large adherence surface area of the inner circumference resin layer 34a, 34b to the insert member 28 is ensured, and the problem of peeling and the like is avoided.

Furthermore, by having the joint part of the attachment unit 20 and the inner circumference resin layer 34 adhered on the inner surface of the connection groove 32 formed on the axial direction end part of the insert member 28, it is possible to more effectively prevent falling out of the insert member 28 from the attachment part 20 in the axial direction. In particular with this embodiment, the connection groove 32 is formed at each axial direction end part, and falling out of the insert member 28 from the attachment unit 20 is prevented at both axial direction sides.

Also, as with the inner circumference resin layer 34a, by providing the resin layer along the entire circumference on the inner circumference surface of the inner member 28, it is possible to ensure a high level of freedom for the shape of the inner hole 36a. Specifically, the inner circumference resin layer 34a of this embodiment is formed with roughly a constant thickness along the entire circumference, but by changing the thickness in the circumference direction, it is possible to freely set the shape of the inner hole 36a.

Meanwhile, as with the inner circumference resin layer 34b, if the resin layer is provided partially on the circumference in the vicinity of the forming part of the connection groove 32 with the insert member 28, peeling from the insert member 28 due to contraction or the like after forming of the inner circumference resin layer 34b is effectively prevented.

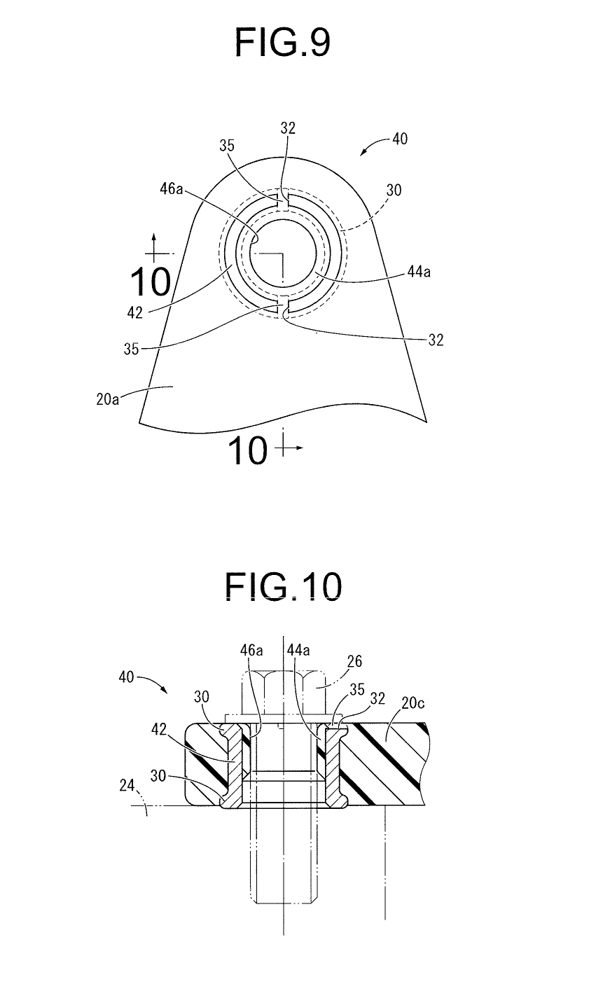

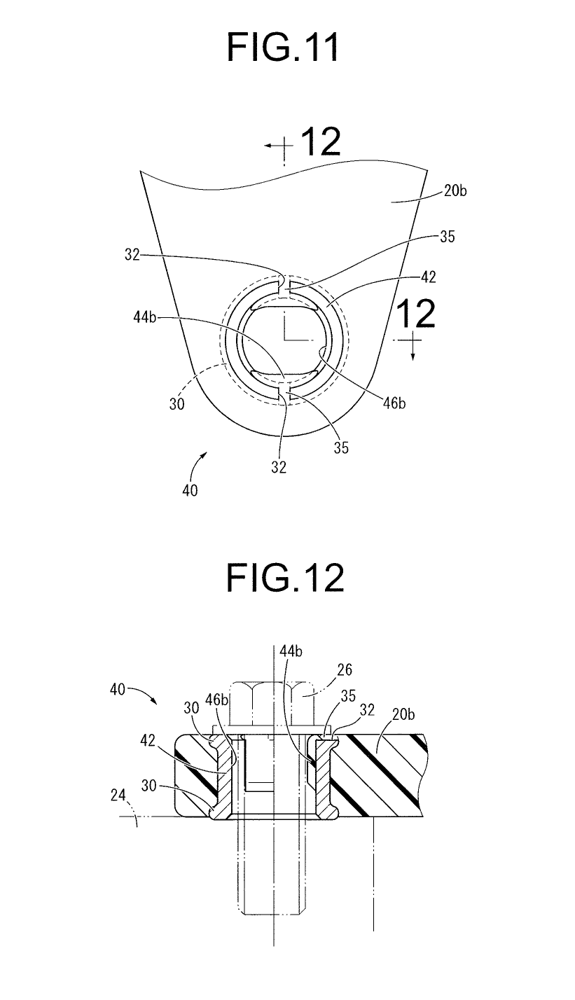

In FIG. 9 through FIG. 12, a resin bracket 40 as the second embodiment of the present invention is shown with the principle part enlarged. With the description hereafter, we will omit a description for substantially the same sites and members as those of the first embodiment by giving the same reference numbers in the drawings. Also, for parts not shown in the drawings, the structure will be the same as that of the resin bracket 14 of the first embodiment.

Specifically, the resin bracket 40 is integrally equipped with the mounting unit 18 and the attachment units 20a to 20c, and insert members 42 are arranged on the respective attachment units 20a to 20c. The insert member 42 is constituted so that the connection groove 32 is formed only on one axial direction end part in contrast to the insert member 28 of the first embodiment, and the remainder of the constitution is the same as that of the insert member 28.

An inner circumference resin layer 44a is adhered along the entire circumference on the inner circumference surface of the insert member 42 adhered to the attachment unit 20a, and the inner circumference resin layer 44a is integrally formed with the attachment unit 20a through the connection groove 32. This inner circumference resin layer 44a is adhered only to the top part of the insert member 42, and the inner circumference surface of the insert member 42 is partially covered in the axial direction by the inner circumference resin layer 44a, while the bottom part of the inner circumference surface of the insert member 42 is exposed on the inside. By doing this, an inner hole 46a which extends vertically with a roughly circular cross section and for which the top part has a smaller diameter than the bottom part is formed on the inside of the insert member 42.

An inner circumference resin layer 44b integrally formed with the attachment unit 20b through the connection groove 32 is adhered to the inner circumference surface of the insert member 42 adhered to the attachment unit 20b. This inner circumference resin layer 44b is provided partially on the circumference in the vicinity of the forming part of the connection groove 32, and the pair of inner circumference resin layers 44b, 44b are arranged facing opposite in the radial direction. Also, the same as the inner circumference resin layer 44a, the inner circumference resin layer 44b is partially adhered only to the top part of the insert member 42, and the inner circumference surface of the insert member 42 is covered partially in the axial direction by the inner circumference resin layer 44b, while the bottom part of the inner circumference surface of the insert member 42 is exposed on the inside. By doing this, on the inside of the insert member 42, an inner hole 46b is formed with the top part extending vertically with a roughly oval shaped cross section, and the bottom part extending vertically with a roughly circular cross section.

In this way, even when the inner circumference resin layers 44a and 44b are provided partially in the axial direction on the inner circumference surface of the insert member 42, the substantial shape of the inner holes 46a and 46b are set by the inner circumference surfaces of the inner circumference resin layers 44a and 44b, and have mutually different shapes. Because of that, the same as with the first preferred embodiment, attachment position deviation of the attachment units 20a to 20c in relation to the vehicle body 24 is allowed, and it is possible to attach the attachment units 20a to 20c to the vehicle body 24. In fact, since the inner circumference resin layers 44a and 44b are provided partially in the axial direction, there is less material for forming the inner circumference resin layers 44a and 44b, and further cost reductions are realized.

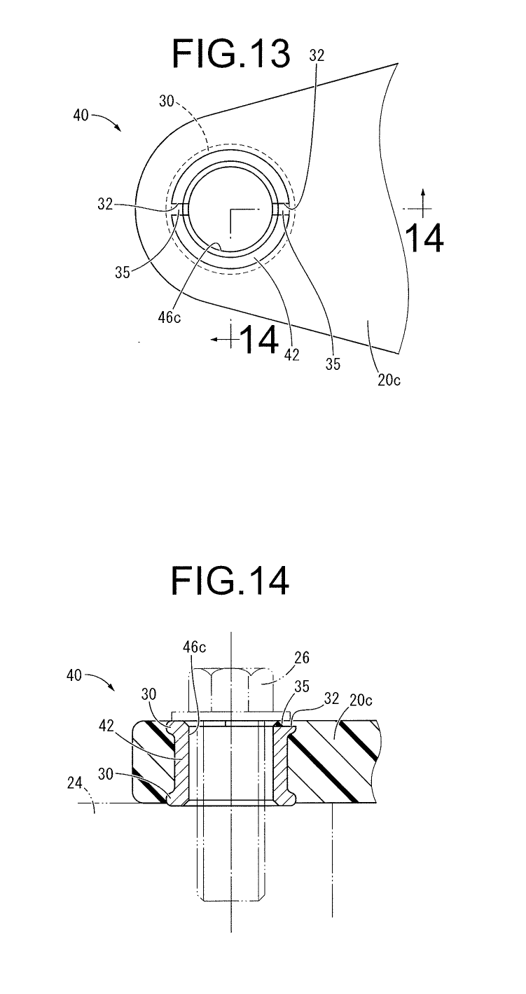

As shown in FIG. 13, other than the fact that with the attachment unit 20c equipped with the insert member 42, the locking portion 35 is formed only inside the connection groove 32 on the top side, and the overlapping surface of the insert member 42 with the vehicle body 24 projecting further to the outside than the attachment unit 20c, the remainder is roughly the same constitution as the attachment unit 20c equipped with the insert member 28 shown in the first embodiment, so a description of the inner hole 46c and the like is omitted.

It is also possible to form the inner circumference resin layer 44a, 44b of the second embodiment on the insert member 28 of the first embodiment, and for example, it is possible to provide the inner hole 36a formed by adhering of the inner circumference resin layer 34a, the inner hole 46a formed by adhering of the inner circumference resin layer 44a, and the inner hole 46b formed by adhering of the inner circumference resin layer 44b in the three insert members 28 of the resin bracket.

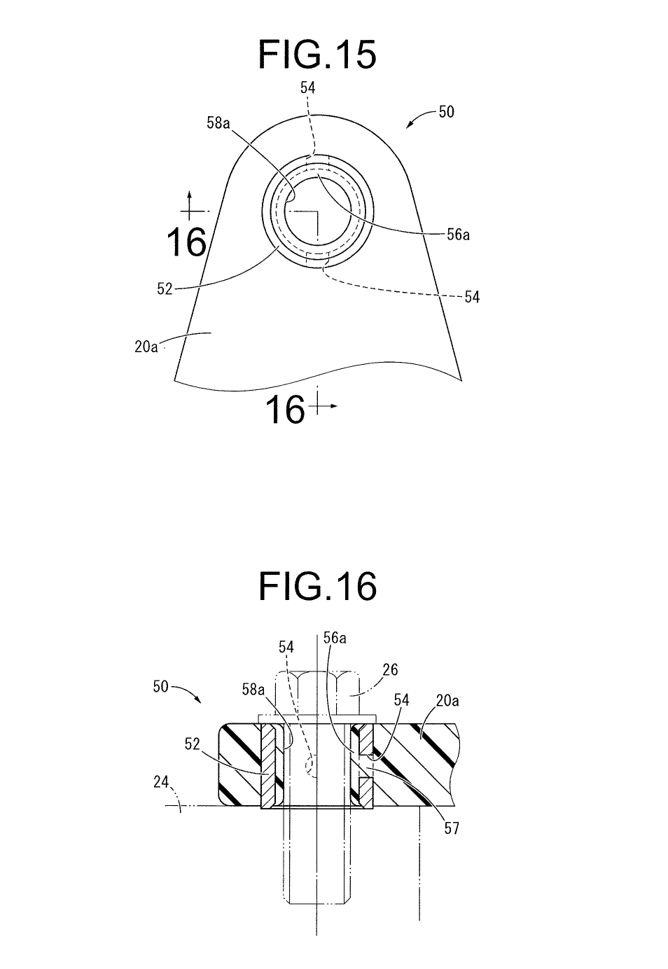

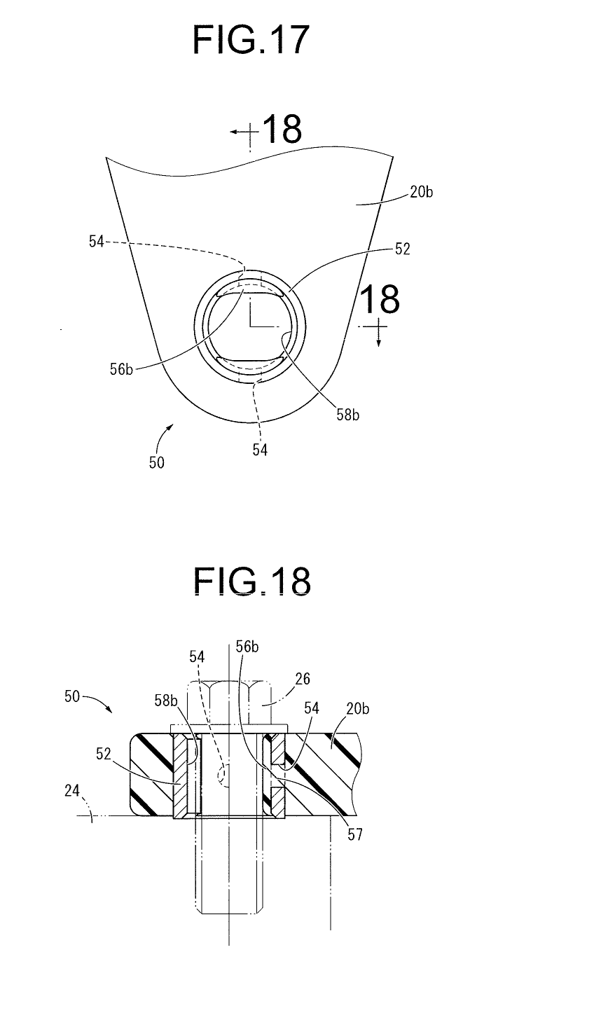

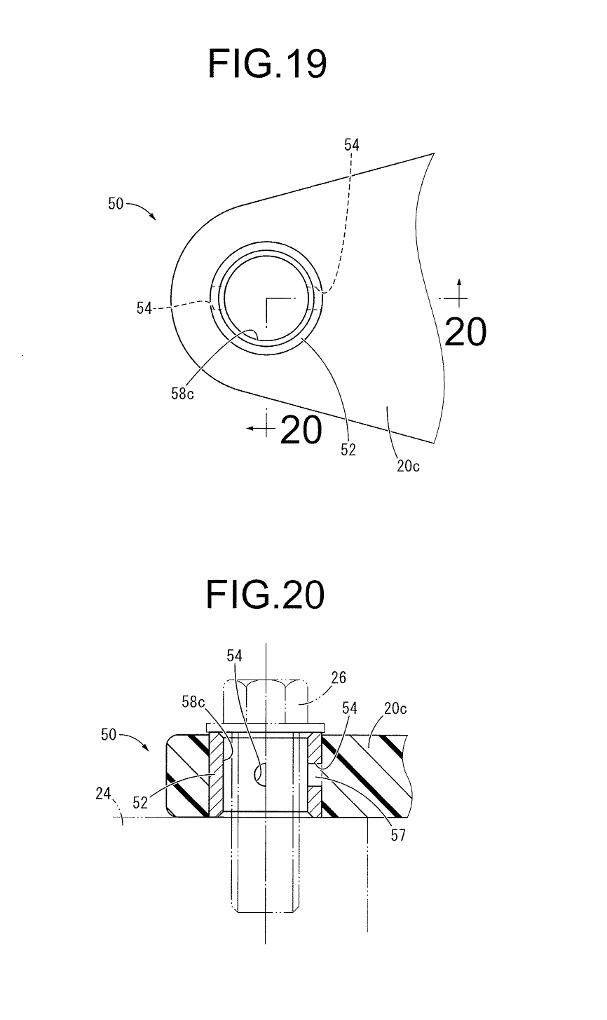

FIG. 15 to FIG. 20 show a resin bracket 50 as a third embodiment of the present invention with the principle part enlarged. The resin bracket 50 is integrally equipped with the mounting unit 18 and the attachment units 20a to 20c.

Insert members 52 are arranged on the respective attachment units 20a to 20c. The insert member 52 is a pipe metal member formed by the drawing process or the like, and is a member having a roughly round tube shape extending in a straight line. Also, a pair of connection holes 54, 54 are formed piercing through in one radial direction of the axial direction center part in the insert member 52, and the inside and the outside of the insert member 52 are put in communication by those connection holes 54, 54.

Then, the three insert members 52 are adhered to the respective attachment units 20a to 20c by insert forming. An inner circumference resin layer 56a is adhered to the inner circumference surface of the insert member 42 adhered to the attachment unit 20a. The inner circumference resin layer 56a has a roughly round tube shape, and is adhered along roughly the entire surface to the inner circumference surface of the insert member 52. Furthermore, the inner circumference resin layer 56a is integrally formed with the attachment unit 20a through the connection holes 54, 54 formed on the insert member 52, and a locking portion 57 that join the attachment unit 20a and the inner circumference resin layer 56a is adhered to the inner surface of the connection hole 54. By this kind of inner circumference resin layer 56a being adhered to the inner circumference surface of the insert member 52, an inner hole 58a with a small diameter circular cross section is formed extending piercing vertically on the inside of the insert member 52 arranged on the attachment unit 20a. Also, by the locking portion 57 being locked in the connection hole 54, the insert member 52 is positioned in the axial direction in relation to the attachment unit 20a, thus constituting the positioning member of this embodiment. Such a positioning member is also provided on the attachment units 20b and 20c described later, and the insert members 52 are held positioned in relation to the respective attachment units 20a to 20c.

Also, an inner circumference resin layer 56b is adhered to the inner circumference surface of the insert member 52 arranged on the attachment unit 20b. The inner circumference resin layer 56b broadens in width to some degree at both sides in the circumference direction from the connection hole 54 forming part, and a pair of inner circumference resin layers 56b, 56b are formed facing opposite in one radial direction. Furthermore, the inner circumference resin layers 56b, 56b are integrally formed with the attachment unit 20b through the connection holes 54, 54 formed on the insert member 52, and are mutually joined with the attachment unit 20b by the locking portion 57 adhered to the inner surface of the connection holes 54, 54. By this kind of inner circumference resin layer 56b being adhered to the inner circumference surface of the insert member 52, on the inside of the insert member 52 arranged on the attachment unit 20b, an inner hole 58b is formed extending piercing vertically with a roughly oval cross section.

With the insert member 52 arranged on the attachment unit 20c, the outer circumference surface is adhered to the attachment unit 20c, and the locking portion 57 integrally formed with the attachment unit 20c on each connection hole 54 is inserted and adhered. Furthermore, the inner circumference surface of the insert member 52 arranged on the attachment unit 20c is exposed without being covered by the resin layer, and on the inside of the insert member 52 arranged on the attachment unit 20c, an inner hole 58c is formed extending piercing vertically with a roughly circular cross section with a larger diameter than the inner hole 58a.

Even with a resin bracket 50 having such a constitution, by having the inner circumference resin layers 56a and 56b adhered to the inner circumference surface of the insert member 52, it is possible to form one each of the inner holes 58a to 58c having mutually different shapes on the inside of the three insert members 52 having the same shape. Therefore, attachment position deviation due to member dimension error or the like is allowed, attachment defects of the resin bracket 50 to the vehicle body 24 are avoided, and by making the diameter of the bolt 26 different according to the required load bearing capacity or the like, it is possible to use mutually different joining constitutions with the attachment units 20a to 20c. As is also clear from this embodiment, the insert member is not limited to being a forged metal member, but can also be a pipe metal member, a cast metal member or the like.

Also, with the insert member 52 of this embodiment, the locking portion 57 integrally formed with the corresponding attachment unit 20a to 20c is inserted in and adhered to the connection holes 54, 54, thus constituting the positioning member. By doing this, even when the insert member 52 is a straight pipe metal member, by the locking of the locking portion 57 and the inner surface of the connection hole 54, falling out of the insert member 52 from the corresponding attachment unit 20a to 20c is prevented at both axial direction sides.

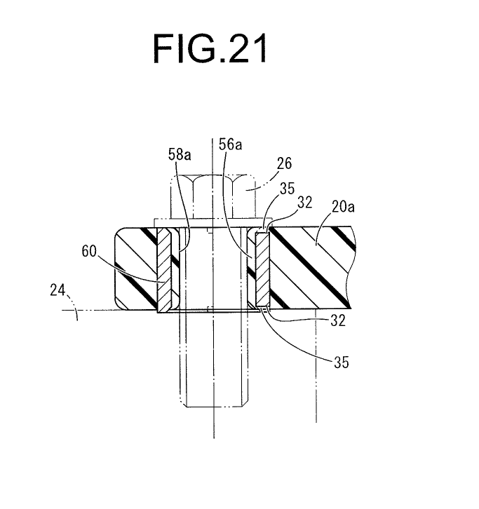

As with an insert member 60 shown in FIG. 21, with the insert member 60 formed using a pipe metal member, instead of the connection hole 54 of the axial direction center part, it is also possible to form the connection groove 32 like that shown in the first embodiment at both axial direction end parts. By doing this, the attachment unit 20a and the inner circumference resin layer 56a are integrally joined through the connection groove 32, and the insert member 60 is positioned in the axial direction in relation to the attachment unit 20a by the locking portion 35 adhered on the inner surface of the connection groove 32, making it possible to prevent falling out.

Above, we gave a detailed description regarding embodiments of the present invention, but the present invention is not limited to those specific notations. For example, with the embodiments noted above, all the inner holes of the plurality of insert members have different shapes, but it is sufficient that the inner hole of at least one insert member has a different shape from the inner hole of at least one other insert member. In specific terms, for example, it is also possible to have the inner hole 36a, the inner hole 36a, and the inner hole 36b be formed on the three insert members 28.

Also, as the shape of the inner holes 36a to 36c, with the embodiments noted above, shown as examples are the inner hole 36a with the small-diameter circular cross section, the inner hole 36b with the oval shaped cross section, and the inner hole 36c with the large-diameter circular cross section, but the shape of the inner holes is not particularly restricted. In specific terms, for example, it is also possible to form inner holes having a small diameter oval shaped cross section by adhering the inner circumference resin layer 34 along the entire circumference to the inner circumference surface of the insert member 28, and also changing the thickness dimension of the inner circumference resin layer 34 in the circumference direction. Furthermore, it is also possible to change the thickness dimension of the inner circumference resin layer 34 in the axial direction so as to change the horizontal cross section shape of the inner hole in the axial direction. The inner circumference resin layer can also be partially adhered midway in the axial direction in relation to the inner circumference surface of the insert member.

Furthermore, with the embodiments noted above, examples are shown with the same bolt 26 inserted through the inner holes 36a to 36c, but for example, it is also possible to have connecting members (bolts or the like) of mutually different diameters or cross section shapes or the like inserted according to the difference in shape of the inner holes 36a to 36c.

Also, the number formed, the arrangement of, and the cross section shape or the like of the connection grooves or connection holes formed on the insert member are not particularly restricted. Furthermore, the connection grooves and connection holes do not absolutely have to have only one be selectively used, and by providing both, it is possible to expect an effect of increasing the filling ability of the resin material in the inside of the insert member or the like.

Also, the number of attachment units or the number of insert members with the resin bracket is not particularly restricted. Furthermore, there are cases when a plurality of insert members are arranged on one attachment unit.

Furthermore, for the resin bracket, as long as a constitution is used with the mounting unit and the attachment unit integrally equipped, for example, it is possible to have a separate member with the goal of being a stopper member attachment or for reinforcement or the like adhered by attaching later.

Also, the constitution of the vibration damping device is merely shown as an example, and various known constitutions can be used. In specific terms, for example, as shown with Japanese Unexamined Patent Publication No. JP-A-2012-013153, it is also possible to have a constitution whereby a first attachment member attached to a first member constituting the vibration transmission system and a second attachment member attached to a second member constituting the vibration transmission system have a vibration damping device main unit elastically connected by a main rubber elastic body, and the mounting unit of the resin bracket is mounted on the second attachment member of that vibration damping device main unit. Furthermore, the present invention can be used preferably even on fluid-filled vibration damping devices such as that shown in JP-A-2012-013153.

The applicable range of the present invention is not limited to the vibration damping device and the resin bracket thereof used for an automobile, and can also be applied to a vibration damping device and the resin bracket thereof used for motorcycles, railroad cars, industrial vehicles or the like. Also, the present invention is not limited to being applied only to engine mounts, but can also be preferably applied for various types of vibration damping device such as a sub-frame mount, body mount, differential mount or the like.

What is claimed is:

1. A resin bracket comprising:
a mounting unit configured to be attached to a vibration damping device;
a plurality of attachment units configured to be attached to a member constituting a vibration transmission system, the mounting unit and the attachment units being integrally formed using synthetic resin; and
a plurality of insert members arranged on the respective attachment units such that each of the attachment units is configured to be attached to the member constituting the vibration transmission system by a fastening member configured to be inserted in an inner hole formed on an inside of the corresponding insert member, wherein
the insert members are formed in mutually a same shape,
an inner circumference resin layer integrally formed with the attachment unit is adhered to an inner circumference surface on at least one of the insert members, and
the inner hole of the insert member formed on the inside of the inner circumference resin layer has a different shape from the inner hole of at least one other insert member.

2. The resin bracket according to claim 1, wherein
at an opening end surface of the inner hole of the at least one insert member, a connection groove connecting the inside and an outside of the insert member is formed, and
the attachment unit and the inner circumference resin layer are integrally formed through the connection groove.

3. The resin bracket according to claim 2, wherein the connection groove is formed on each opening end surface of the inner hole of the at least one insert member, and the attachment unit and the inner circumference resin layer are integrally formed through each connection groove.

4. The resin bracket according to claim 1, wherein
the insert member comprises a tube shaped forged metal member,
a positioning projection is provided on the insert member projecting facing an outer circumference, and
a positioning member that positions the insert member in relation to the attachment unit is constituted by the positioning projection.

5. The resin bracket according to claim 1, wherein the insert member comprises a pipe metal member, and a positioning member is provided for positioning the insert member in relation to the attachment unit.

6. The resin bracket according to claim 5, wherein a connection hole that connects the inside and an outside is formed piercing through the insert member, and the attachment unit and the inner circumference resin layer are integrally formed through the connection hole.

7. The resin bracket according to claim 1, wherein the inner circumference resin layer is partially adhered to the inner circumference surface of the insert member.

8. The resin bracket according to claim 1, wherein the inner circumference resin layer is adhered along an entire circumference in relation to the inner circumference surface of the insert member.

9. A bracketed vibration damping device comprising:
an attachment member configured to be attached to a first member constituting a vibration transmission system;
a main rubber elastic body adhered to the attachment member; and
a resin bracket including: a mounting unit; a plurality of attachment units configured to be attached to a second member constituting the vibration transmission system, the mounting unit and the attachment units being integrally formed using synthetic resin; and a plurality of insert members arranged on the respective attachment units such that each of the attachment units is configured to be attached to the second member constituting the vibration transmission system by a fastening member configured to be inserted in an inner hole formed on an inside of the corresponding insert member, wherein the insert members are formed in mutually a same shape, an inner circumference resin layer integrally formed with the attachment unit is adhered to an inner circumference surface on at least one of the insert members, and the inner hole of the insert member formed on the inside of the inner circumference resin layer has a different shape from the inner hole of at least one other insert member, wherein
the attachment member and the mounting unit of the resin bracket are elastically connected by the main rubber elastic body.
